(19) United States
(12) Patent Application Publication
(10) Pub. No.: US 2021/0354210 A1
(43) Pub. Date: Nov. 18, 2021

(54) Cutting tool and method for producing a cutting tool

(71) Applicant: KENNAMETAL INC., Latrobe, PA (US)

(72) Inventors: Jürgen Schwägerl, Vohensrauss (DE); Herbert Rudolf Kauper, Erlangen (DE)

(21) Appl. No.: 17/314,343

(22) Filed: May 7, 2021

(30) Foreign Application Priority Data
May 12, 2020 (DE) 102020112808.8

(51) Int. Cl. B23B 51/06; B23B 51/02

(52) U.S. Cl. CPC B23B 51/06; B23B 51/02; B23B 2251/207; B23B 2250/12; B23B 2251/408

(57) ABSTRACT

A cutting tool for machining workpieces is disclosed, which comprises a shank portion and a cutting portion, wherein a coolant channel extends along a longitudinal axis from a free end of the shank portion through the cutting tool, which has a peripheral wall and an end wall, wherein the coolant channel has one or more outlet openings in the end wall, through which coolant can exit the cutting tool. Also disclosed is a method for producing a cutting tool.

### RELATED APPLICATION DATA

The present application claims priority pursuant to 35 U.S.C. § 119(a) to German Patent Application Number 102020112808.8 filed May 12, 2020 which is hereby incorpated by reference in its entirety.

### FIELD

The invention relates to a cutting tool for machining workpieces and a method for producing a cutting tool.

### BACKGROUND

When machining workpieces using a cutting tool, in particular a rotating cutting tool, it is customary to guide a coolant to the particularly heavily stressed cutting edges and/or friction surfaces of the cutting tool, in order to reduce wear of the cutting tool resulting from heat generated by friction in the cutting tool.

A coolant is often guided to the particularly heavily stressed regions through coolant channels extending through the cutting tool.

The production of such coolant channels in cutting tools is relatively complex, however, especially because a plurality of coolant channels or channel sections leading to different locations on the cutting tool are usually provided to guide the coolant to the intended regions or to distribute the coolant evenly along the cutting tool.

### SUMMARY

It is therefore an object of the present invention to specify a cutting tool having an optimized channel design or an optimized method for producing a cutting tool.

This object is achieved according to the invention by a cutting tool for machining workpieces, comprising a shank portion and a cutting portion, wherein a coolant channel extends along a longitudinal axis from a free end of the shank portion through the cutting tool, which has a peripheral wall and an end wall, wherein the coolant channel has one or more outlet openings in the end wall, through which coolant can exit the cutting tool.

Such a cutting tool has the advantage that the coolant channel and the outlet openings are particularly easy to produce. It is especially advantageous that only one (large) channel has to be formed in the cutting tool, and that very small outlet openings suffice otherwise.

A further advantage is that the outlet openings open directly, i.e. without the existence of an intermediate channel, into an outer surface of the cutting tool, so that coolant can exit the cutting tool directly through the outlet openings in the end wall of the coolant channel. The coolant is thus immediately available on an outer surface of the cutting tool, in particular on cutting edges and friction surfaces, at the beginning of a machining process.

The cutting tool is in particular free of side channels that branch off from the central coolant channel.

The cutting tool is a reamer or a twist drill, for example.

The coolant channel preferably extends in a straight line exclusively along a longitudinal axis of the cutting tool. This also contributes to making the cutting tool easy to produce. Due to the straight-line course of the coolant channel, a blank for producing the cutting tool is free of undercuts, so that the blank can be produced in a tool mold by injection molding. Alternatively, a green body can be placed into a mold and pressed to produce the blank. However, it is also conceivable to produce the coolant channel by drilling.

According to one embodiment, the plurality of outlet openings open into an end face of the cutting tool. The end face is the surface that can be seen when looking down onto the front end of the cutting portion. This design is useful in particular for reamers, because, for reamers, it is necessary that a coolant be available on the end face as quickly as possible.

Because the outlet openings open into an end face of the cutting tool, at least in reamers, longitudinal grooves are not needed. In conventional reamers, the function of such longitudinal grooves is to convey a coolant exiting laterally from the cutting tool to the end face. However, if the outlet openings open directly into the end face, this conveyance is not necessary. This greatly simplifies the production of the cutting tool.

According to a further embodiment, the plurality of outlet openings can open into a flute of the cutting tool. This design is particularly useful for twist drills. In this case, too, the outlet openings can be disposed near a front end of the cutting portion, for example at a distance of less than 3 mm from a cutting tip.

It is also conceivable that, in the case of a twist drill, the coolant channel is ground only in the groove outlet region. The coolant channel is then preferably only deep enough to reach the groove outlet region.

The coolant channel has a constant cross-section, for example Such a coolant channel is particularly easy to produce. A slight taper can be provided to facilitate removal from the mold. In the case of a coolant channel that has only one such mold release bevel, the cross-section of the coolant channel is still considered to be constant. However, a more pronounced taper is also conceivable.

The coolant channel can alternatively be stepped, wherein at least one additional outlet opening is formed on the stepped portion. This has the advantage that the coolant can be distributed even better along the cutting tool. A plurality of outlet openings spaced apart in the longitudinal direction of the cutting tool can in particular be created.

In step drills, for example, such a stepped coolant channel can serve to provide coolant directly at the drill step. A plurality of outlet openings are preferably also present on the stepped portion.

The cross-section of the coolant channel can be circular, oval, or polygonal. This applies to both the coolant channel having the constant cross-section and the stepped coolant channel.

According to one embodiment, on the end wall of the coolant channel, there is an elevation which projects into the coolant channel. The elevation is preferably disposed centrally on the end wall. Such an elevation has a number of advantages. On the one hand, it reinforces the cutting tool in the region of the end wall. The elevation also enables the formation of a centering bore. The elevation furthermore makes it possible to align the flow of the coolant prior to exiting from the outlet openings, as a result of which the direction in which the coolant exits the cutting tool can be influenced.

At least in sections, a diameter of the coolant channel can be between 60% and 95%, in particular between 75% and 95% of a nominal diameter of the cutting tool. A wall thickness of the cutting tool is between 1 mm and 2 mm, for example. For a non-round cross-section of the coolant channel, at least in sections, a maximum dimension of the cross-section of the coolant channel is in particular between 60% and 95%, in particular between 75% and 95% of a nominal diameter of the cutting tool. The cross-section is the section perpendicular to the longitudinal axis of the cutting tool. The advantage of a cross-section selected in this way is that the use of material to produce the cutting tool is significantly reduced compared to conventional cutting tools.

According to one embodiment, notches or depressions are configured in the end face of the cutting portion, which intersect with the coolant channel. The notches or depressions are implemented to be deep enough to “cut” the coolant channel, so that the outlet openings are created. Before the notches are created, the coolant channel is closed at its end wall.

This has the advantage that no separate work step is required to create the outlet openings, because the outlet openings are formed at the same time as the notches. The production of the cutting tool is thus further simplified.

Furthermore, because the outlet openings are not created until the notches are formed, the same blank can be used as a base body for a variety of cutting tools. This is advantageous with respect to the production process, because larger batches can be produced from one blank.

The number and position of the notches can be selected variably. Also, whether a distance between the notches is uniform or non-uniform can be determined up until the notches are formed. In this case, a circular cross-section of the coolant channel is advantageous, because the shape of the coolant channel does not have to be taken into account when positioning the notches.

The notches can, for example, extend at an angle between 40° and 50° to a longitudinal axis of the cutting tool. However, other angles are conceivable as well.

Instead of notches, flutes can extend along the cutting portion, which intersect with the coolant channel Outlet openings can thus likewise be created in the cutting portion.

The coolant channel ends at a distance of less than 10 mm, in particular less than 2 mm, for example, from a front end of the cutting portion. This simplifies the opening of the coolant channel, because only a small amount of material has to be removed from the end face of the cutting portion to create the outlet openings.

The object is further achieved according to the invention by a method for producing a cutting tool for machining workpieces, in particular a cutting tool, which is configured as described above, comprising the following steps:
Providing a blank having a shank portion, a cutting portion, and a coolant channel, which has a peripheral wall and an end wall,
Forming notches or depressions on an end face of the cutting portion and thereby creating outlet openings in the end wall of the coolant channel.

Such a method is particularly suitable for producing a reamer. Such a method in particular makes it especially easy to produce a reamer having a coolant channel.

The notches are formed in particular after sintering the blank, for example by milling or grinding. The exact shape of the cutting tool can thus be defined relatively late in the manufacturing process.

The object is further achieved according to the invention by a method for producing a cutting tool for machining workpieces, in particular a cutting tool, which is configured as described above, comprising the following steps:
Providing a blank having a shank portion, a cutting portion, and a coolant channel, which has a peripheral wall and an end wall,
Forming flutes along the cutting portion and thereby creating outlet openings in the end wall of the coolant channel.

According to one embodiment, the coolant channel is stepped and, when the flutes are formed, outlet openings are created in both the end wall of the coolant channel and on the stepped portion of the coolant channel A step drill having outlet openings in the region of the drill step can thus be produced in a particularly simple manner.

Alternatively, the coolant channel can be ground only in the groove outlet region of the flutes. In this case, the coolant channel extends only as far as the groove outlet region.

The blank for producing the cutting tool can be produced by means of injection molding. As a result, large numbers of blanks can be produced particularly easily and cost-effectively.

### BRIEF DESCRIPTION OF THE DRAWINGS

Further advantages and features of the invention result from the following description and from the accompanying drawings, to which reference is made. The drawings show:

FIG. 1 a cutting tool according to the invention in a perspective view,

FIG. 2 a longitudinal section through the cutting tool of FIG. 1,

FIG. 3 a further section through the cutting tool of FIG. 1,

FIG. 4 a plan view onto an end face of the cutting tool of FIG. 1,

FIG. 5 a side view of the cutting tool of FIG. 1,

FIG. 6 a longitudinal section through a cutting tool according to a further embodiment according to the invention,

FIG. 7 a cutting tool according to the invention according to a further embodiment,

FIG. 8 a detail view of the cutting tool of FIG. 7 in the region of the cutting tip,

FIG. 9 a cutting tool according to the invention according to a further embodiment,

FIG. 10 a cutting tool according to the invention according to a further embodiment in a side view,

FIG. 11 the cutting tool of FIG. 10 in a plan view, and

FIG. 12 the cutting tool of FIG. 10 in a rear view.

### DETAILED DESCRIPTION

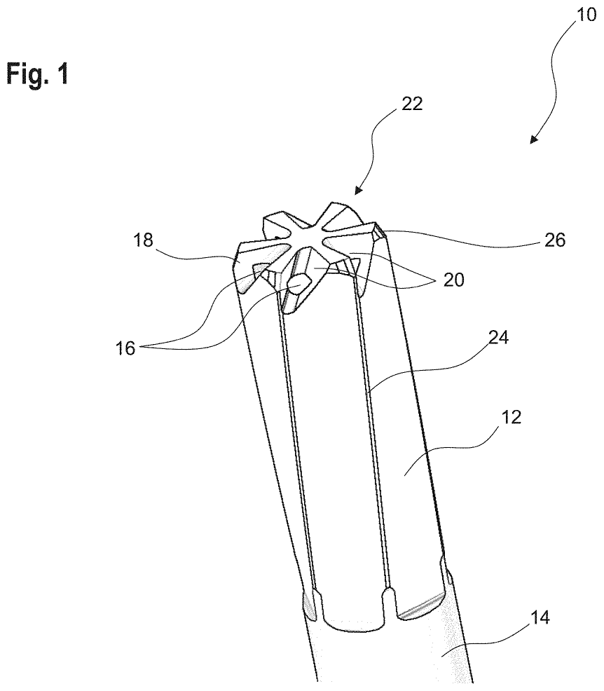

FIG. 1 shows a cutting tool 10 for machining a workpiece in a perspective view. The cutting tool 10 shown in FIG. 1 is in particular a reamer. The cutting tool 10 has a cutting portion 12 and a shank portion 14, wherein the shank portion 14 has been shortened in the drawing.

The cutting tool 10 comprises a plurality of outlet openings 16, through which coolant can exit the cutting tool 10.

The outlet openings 16 open into an end face 18 of the cutting tool 10. The end face 18 refers to the surface that is visible in a plan view onto a tip of the cutting portion 12. Coolant exiting from the outlet openings 16 is thus available at the end face 18 immediately after exiting the cutting tool 10.

A plurality of notches 20 or depressions are also formed at one end of the cutting portion 12. The notches 20 extend from a front end 22 of the cutting portion 12, at a 45° angle to the longitudinal axis of the cutting tool 10.

The notches 20 in particular form a part of the end face 18.

The outlet openings 16 are disposed in the notches 20.

Starting from the end face 18, a plurality of guide surfaces 24 extend along the cutting portion 12.

A cut end 26 is further provided at one end of the cutting portion 12, which facilitates the insertion of the cutting tool 10 into a predrilled hole, for example.

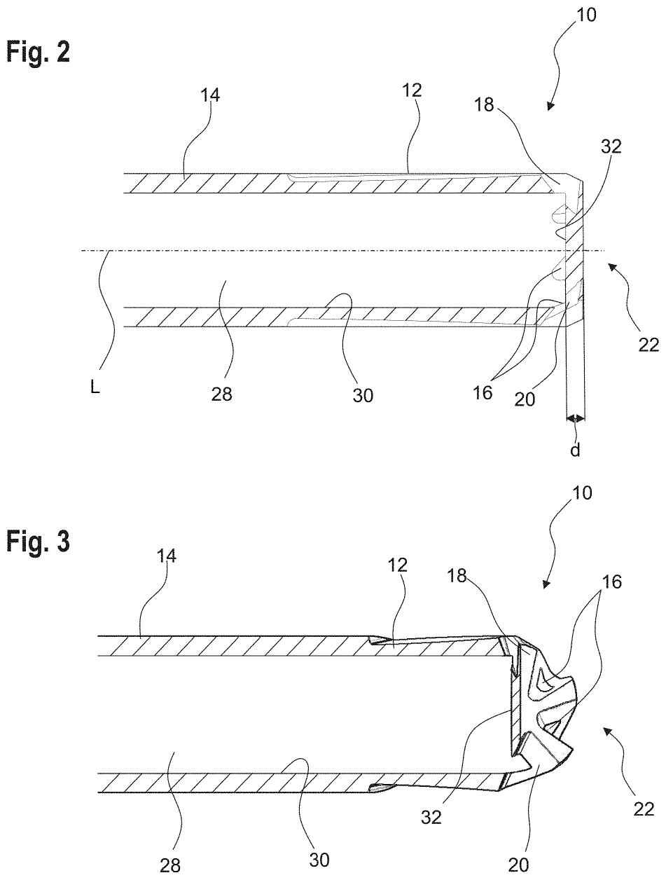

FIG. 2 shows a longitudinal section through the cutting tool 10 of FIG. 1. FIG. 3 shows a supplementary perspective sectional view through the cutting tool 10.

In the sectional views, it can be seen that a coolant channel 28 extends through the cutting tool 10. More precisely, the coolant channel 28 extends along a longitudinal axis L from a free end of the shank portion 14 through the cutting tool 10.

The coolant channel 28 extends in a straight line exclusively along the longitudinal axis L of the cutting tool 10. This means that the coolant channel 28 is free of branches and the coolant channel 28 does not curve and/or bend sharply.

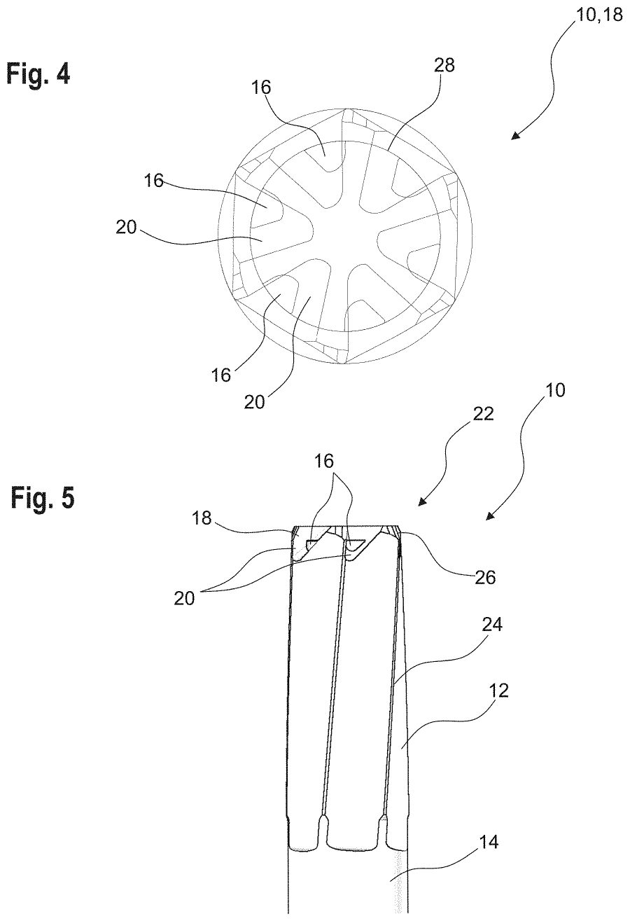

The coolant channel 28 has a constant cross-section, in particular a round cross-section (see also FIG. 4). However, other cross-sectional shapes are conceivable as well.

A diameter of the coolant channel 28 can be between 60% and 95% of a nominal diameter of the cutting tool 10. In the depicted design example, the diameter of the coolant channel 28 is approximately 75% of the nominal diameter of the cutting tool 10.

The coolant channel 28 has a peripheral wall 30 and an end wall 32. The outlet openings 16 are formed in the end wall 32 of the coolant channel 28.

As can be seen in FIG. 2, the outlet openings 16 can extend a short distance into the peripheral wall 30. However, there are no outlet openings 16 that are not formed at least in sections in the end wall 32. In other words, the outlet openings 16 are disposed in the region of an edge between the peripheral wall 30 and the end wall 32, wherein the outlet openings 16 extend beyond the edge.

The notches 20 intersect with the coolant channel 28, as can be seen in FIG. 2. The outlet openings 16 are thus formed by the notches 20. The size of the outlet openings 16 depends on the size of the intersection of the notches 20 with the coolant channel 28.

In the shown design example, the notches 20 extend at an approximately 45° angle to the longitudinal axis L of the cutting tool 10, wherein the notches 20 are slightly curved when viewed in section.

A distance d of the end wall 32 to a front end of the cutting portion 12 is less than 10 mm, for example, in particular less than 2 mm.

FIG. 4 shows a plan view onto the cutting portion 12. FIG. 4 in particular shows the end face 18 of the cutting tool 10. The cutting tool 10 is transparent in the drawing, so that a position of the coolant channel 28 in the cutting tool 10 and an outline of the coolant channel 28 can be seen.

FIGS. 2 and 4 show that, both in side view and in plan view, the outlet openings 16 have approximately the shape of a divided oval. Therefore, viewed as a whole, the outlet openings 16 have an approximately oval shape.

FIG. 5 shows a side view of the cutting tool 10. FIG. 5 shows that the cutting portion 12 tapers toward the end face 18.

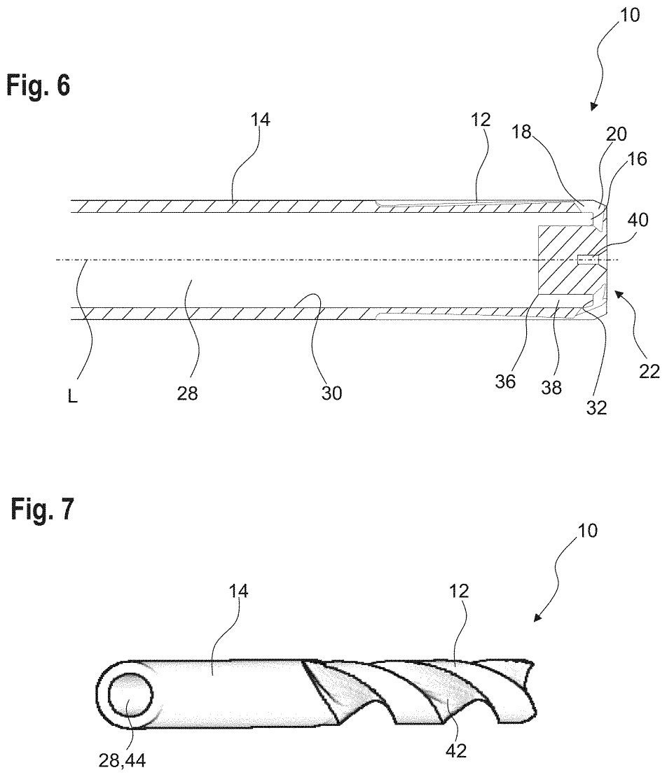

FIG. 6 shows a longitudinal section through a cutting tool 10 according to a further embodiment. The embodiment depicted in FIG. 6 differs from the embodiment described with reference to FIGS. 1 to 5 in that an elevation 34 is disposed on the end wall 32 of the coolant channel 28, which projects into the coolant channel 28. The elevation 34 is in particular disposed centrally in the coolant channel 28, i.e. a central axis of the elevation 34 is superimposed on the longitudinal axis L of the cutting tool 10.

The elevation 34 ensures improved stability of the cutting tool 10 in the region of the end wall 32.

The elevation 34 moreover forms an annular channel section 38 of the coolant channel 28, which ensures that the coolant flows specifically to the outlet openings 16.

The elevation 34 also provides a large enough thickness of material in the region of the end face 18 of the cutting tool 10 to create a centering bore 40 in the end face 18. The centering bore 40 facilitates the clamping of the cutting tool 10, for example for the purpose of reconditioning the cutting tool 10.

In the design example shown, the elevation 34 is cylindrical.

The elevation 34 can optionally have a rounding or a chamfer on its free peripheral edge 36. This has an advantageous effect on the flow behavior of the coolant in the coolant channel 28.

FIG. 7 shows a further embodiment of the cutting tool 10. The cutting tool 10 shown in FIG. 7 is a twist drill, along the cutting portion 12 of which a plurality of flutes 42 extend.

The cutting tool 10 according to FIG. 7 likewise comprises a coolant channel 28.

FIG. 7 shows an inlet opening 44 of the coolant channel 28. As in the previously described embodiments, the end wall 32 of the coolant channel 28 is disposed near the front end of the cutting portion 12, for example at a distance of less than 5 mm, in particular at a distance of less than 2 mm to a cutting edge 48 of the cutting tool 10.

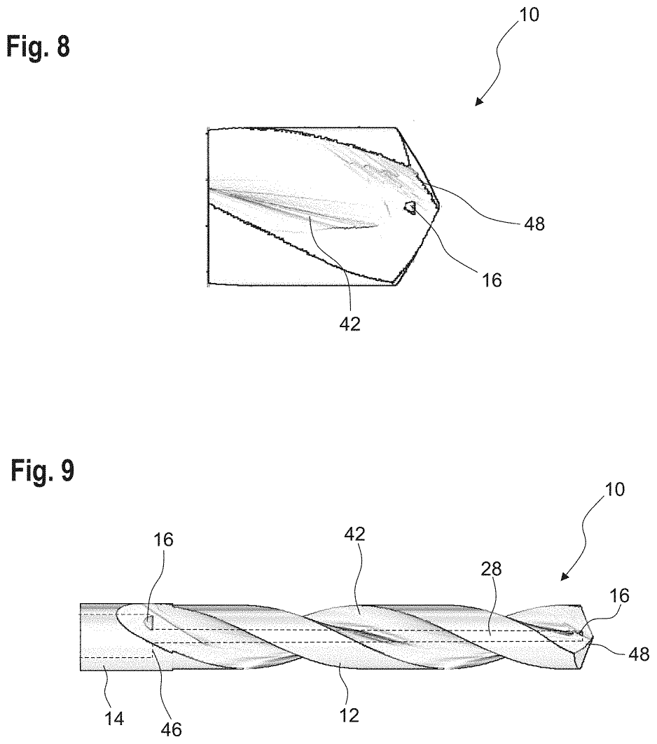

As can be seen in FIG. 8, which shows a detail view of the cutting tool 10 of FIG. 7 in the region of a cutting tip of the cutting tool 10, the outlet openings 16 are disposed inside the flutes 42.

By contrast to the previous embodiments, the coolant channel 28 has a smaller diameter in the region of the cutting portion 12, for example a diameter of less than 40% of the nominal diameter. Otherwise, the flutes 42 would open excessively large outlet openings 16 in the cutting tool 10. This can be achieved, for example, by the coolant channel 28 being stepped or having a smaller cross-section along its entire length.

In the embodiment shown in FIGS. 7 and 8, in which outlet openings 16 are provided only near the cutting tip, the stepped portion is preferably located in the region of the shank portion 14. The stepped portion then serves only to facilitate the removal of the cutting tool 10 from the mold.

FIG. 9 shows a further embodiment of a cutting tool 10. The cutting tool 10 depicted in FIG. 9 is similar to the cutting tool 10 shown in FIGS. 7 and 8 and is likewise a twist drill.

The cutting tool 10 depicted in FIG. 9 also has a stepped coolant channel 28. For better illustration, the coolant channel 28 is shown as a dashed line in FIG. 9.

The stepped portion 46 makes it possible to easily create a plurality of outlet openings 16 which are spaced apart in longitudinal direction. At least one outlet opening 16 is in particular disposed on the stepped portion 46. In this case, the stepped portion 46 is disposed in the region of the cutting portion 12.

A method for producing a cutting tool 10 according to FIGS. 1 to 6 and a method for producing a cutting tool 10 according to FIGS. 7 to 9 are described in the following.

In both cases, a blank is first provided, which has a shank portion 14, a cutting portion 12 and a coolant channel 28, wherein the coolant channel has a peripheral wall 30 and an end wall 32.

The blank is produced by injection molding, for example. The blank is then sintered.

Preferably after sintering, notches 20 are formed on an end face of the cutting portion 12, for example by means of milling or grinding. As a result, the outlet openings 16 are created in the end wall 32 of the coolant channel 28.

Instead of notches 20, flutes 42 can also be created along the cutting portion 12. This likewise creates outlet openings 16 in the end wall 32 of the coolant channel 28.

When the coolant channel 28 is stepped, outlet openings 16 can be created in both the end wall 32 of the coolant channel 28 and on the stepped portion 46 of the coolant channel 28 when the flutes 42 are formed.

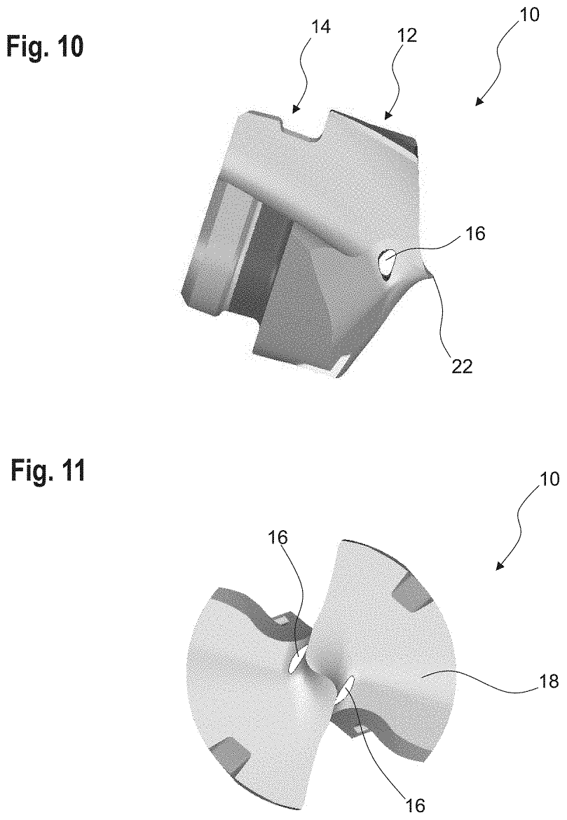

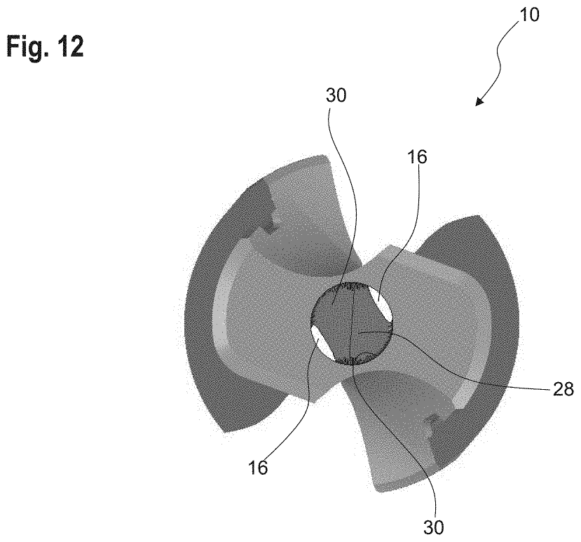

FIGS. 10 to 12 show a further embodiment of a cutting tool 10, wherein FIG. 10 shows the cutting tool 10 in a side view, FIG. 11 shows the cutting tool 10 in a plan view onto the end face 18, and FIG. 12 shows the cutting tool 10 in a rear view.

In FIG. 10, it can be seen that the cutting tool 10 also has a shank portion 14 and a cutting portion 12.

A coolant channel 28 again extends along a longitudinal axis from a free end of the shank portion 14 through the cutting tool 10, which has two outlet openings 16 in the end wall through which coolant can exit the cutting tool 10.

The cutting tool 10 shown in FIGS. 10 to 12 is a drill tip, which can be used as a wear part in a twist drill, for example.

The cutting tool 10 according to FIGS. 10 to 12 is fundamentally the same as the cutting tool shown in FIGS. 7 and 8, but is much shorter in comparison.

1. A cutting tool for machining workpieces, comprising a shank portion and a cutting portion, wherein a coolant channel extends along a longitudinal axis from a free end of the shank portion through the cutting tool, which has a peripheral wall and an end wall, wherein the coolant channel has one or more outlet openings in the end wall, through which coolant can exit the cutting tool.

2. The cutting tool according to claim 1, wherein the coolant channel extends in a straight line exclusively along a longitudinal axis of the cutting tool.

3. The cutting tool according to claim 1, wherein the coolant channel has a constant cross-section.

4. The cutting tool according to claim 1, wherein the coolant channel is stepped, wherein at least one additional outlet opening is formed on the stepped portion.

5. The cutting tool according to claim 1, wherein, on the end wall of the coolant channel, there is an elevation which projects into the coolant channel.

6. The cutting tool according to claim 1, wherein, at least in sections, a diameter of the coolant channel is between 60% and 95% of a nominal diameter of the cutting tool.

7. The cutting tool according to claim 1, wherein notches or depressions are configured in an end face of the cutting portion, which intersect with the coolant channel.

8. The cutting tool according to claim 1, wherein flutes extend along the cutting portion, which intersect with the coolant channel.

9. The cutting tool according to claim 1, wherein the coolant channel ends at a distance of less than 10 mm from a front end of the cutting portion.

10. A method for producing a cutting tool for machining workpieces comprising:
providing a blank having a shank portion, a cutting portion, and a coolant channel, which has a peripheral wall and an end wall,
forming notches or depressions on an end face of the cutting portion and thereby creating outlet openings in the end wall of the coolant channel.

11. The method according to claim 10, wherein the blank is sintered and the notches or depressions are formed after sintering the blank, for example by means of milling or grinding.

12. A method for producing a cutting tool for machining workpieces comprising:
providing a blank having a shank portion, a cutting portion, and a coolant channel, which has a peripheral wall and an end wall,
forming flutes along the cutting portion and thereby creating outlet openings in the end wall of the coolant channel.

13. The method according to claim 12, characterized in that the coolant channel is stepped and, when the flutes are formed, outlet openings are created in both the end wall of the coolant channel and on the stepped portion of the coolant channel.

14. The method according to claim 12, wherein the blank is produced by means of injection molding.
